(19) United States
(12) Patent Application Publication
(10) Pub. No.: US 2011/0178649 A1
(43) Pub. Date: Jul. 21, 2011

(54) METHOD FOR PREVENTING ELECTRIC SHOCK BY CONTACT WITH CONNECTED-TO-GROUND ELECTRIC APPLIANCES AND INSTALLATIONS, AND APPARATUS THEREFOR

(76) Inventor: Giovanni Pieri, Viareggio (IT)

(21) Appl. No.: 13/058,868

(22) PCT Filed: Aug. 14, 2009
(86) PCT No.: PCT/IB2009/006554

§ 371 Date: Mar. 23, 2011

(30) Foreign Application Priority Data
Aug. 14, 2008 (IT) LU2008A000013

(51) Int. Cl. G06F 1/28

(52) U.S. Cl. 700/293

(57) ABSTRACT

A safety method and safety apparatus of an electric installation (2) that is powered through an electric supply line (3), and has a ground wire (9). The safety apparatus comprises a means (400A) for automatically measuring (71) the voltage (ΔV) that is established between the neutral point (1,23) of the transformer (26) of an electric supplying network and the ground wire (9). A comparison (74) is then made between the measured voltage (ΔV) and an alarm voltage value (ΔV). Finally, a switch (33) is activated (79) by means of a control device (370), when the measured voltage (ΔV) exceeds an alarm voltage value (ΔV), and the electric supply line (3) is automatically disconnected from the electric installation (2). The invention is adapted to prevent, in particular, dangerous contact voltages from building up on the a ground terminal that is shared by all the electric installations of a living unit of multifloor building that would be transferred to all the electric installations that are connected to ground. In an voltamperometric exemplary embodiment, a selective opening is possible of the switches pertaining the living unit that have caused the dangerous voltage to build up, for example in case of failure of a residual current circuit breaker device. The system may also provide giving a pre-alarm, for voltage values that are close to the dangerous voltage value, or turning off the electric supply to the circuits of each living unit (according to a possible preference) that produce a ground current greater than a design value. The system may also provide steadily detecting a ground resistance.

### FIELD OF THE INVENTION

The present invention relates to a method for preventing electric shock by contact with parts of electric appliances and installations, in particular, in single or multiple living units.

The invention relates furthermore to an apparatus that carries out this method.

### TECHNICAL PROBLEM

An important cause of electric shocks, which are often lethal, is the presence of anomalous voltage in grounding devices. Such voltage is transmitted to all the grounded metal parts of the electrical appliances of a block of flats; these metals parts may comprise knobs and cases of electric appliances, therefore the voltage can be dangerous for users if it exceeds the limits of the so-called very-low voltage (normally 50V).

Such a drawback may take place owing to many reasons. In a first case, a ground current may flow towards ground due to an insulation fault of an appliance that is electrically supplied by an installation whose residual current circuit breaker device is out of service, or, in particular, no residual current circuit breaker device is installed.

In a second case, a plurality of ground currents may be produced by respective living units, each of them lower than a safety threshold value, but suitable for building up together an overall current which may achieve a dangerous value. More in detail, this may occur since the residual current circuit breaker devices, even if they are in order, have a working tolerance, i.e. they do not switch if the respective ground currents are lower than a threshold value, which may depend upon local rules, normally, 0.15 mA. Such “small” dispersions may even be very frequent, due to both detection sensitivity and maintenance negligence. In the case of a structure formed by many user groups, each of them powered through a respective independent installation, for example a big block of flats, the ground wire of each installation is connected to a common ground wire, which is also called the equipotential bar or the common ground terminal, that is in turn connected to ground. Therefore, if on each living unit ground wire a current circulates that may be lower than a threshold safety value, which is not detected by a working residual current circuit breaker device, an overall ground current contribution can circulate on the common ground terminal, whose voltage is responsive to the overall ground current and the ground resistance. The higher is the number of current contributions to the overall ground current, and the higher is the ground resistance, responsive for instance to aquifer depth, the higher is this voltage.

In a third case, the anomalous voltage in the grounding device may occur due to design or installation mistakes, which may be caused by a too high ground resistance design value.

In a fourth case, someone may have the intention of causing harm to people by tampering the common ground terminal, which may for instance be disconnected from the ground or even connected to a voltage source.

### SUMMARY OF THE INVENTION

It is therefore a feature of the invention to provide a method and a device for preventing an anomalous voltage from building up in the ground wire of an electric installation, in particular, for preventing an anomalous voltage in the common ground terminal of an installation of a block of living units.

It is a particular feature of the invention to provide such method and device for making up for the failure of a residual current circuit breaker device that is in use as a safety device for the electric installation.

It is, furthermore, a feature of the invention to provide a method and a device for signalling an anomalous voltage in the ground wire of an electric installation, to allow well-timed corrective measures.

It is a particular feature of the invention to provide a method and a device for signalling the ground resistance value of an installation, to allow locally or remotely checking the plant.

These and other objects are achieved by a safety apparatus for an electric installation, the electric installation powered through an electric supply line, the electric supply line having a neutral wire and a live wire, the electric installation having a ground wire;

the apparatus comprising:

a voltage measuring means, for automatically measuring a voltage that is established between a neutral point and the ground wire;

a circuit breaker means that is adapted to work responsive to the voltage measuring means, for automatically disconnecting the electric supply line from the electric installation when the voltage between the neutral point and the ground wire exceeds an alarm voltage value.

Advantageously, the apparatus comprises a ground current measuring means for measuring a ground current in the ground wire, and the circuit breaker means is adapted to break the electric supply line from the electric installation when the voltage between the neutral point and the ground wire exceeds the alarm voltage value and when the ground current exceeds an alarm ground current value.

Preferably, a signal means is provided for signalling a pre-alarm voltage value when the voltage between the neutral point and the ground wire exceeds a pre-alarm voltage value that is lower than the alarm voltage value.

In particular, the circuit breaker means comprises a circuit breaker device that has:

a closed position, in which the neutral wire and the live wire of the electric supply line are respectively connected to a corresponding neutral wire and to a live wire of the electric installation;

an open position, in which at least one wire selected from the group comprised of the neutral wire and the live wire of the electric supply line is not connected to the corresponding neutral wire or live wire of the electric installation,

such that a current is allowed to flow/prevented from flowing between the electric line and the electric installation when the circuit breaker device is at the closed/open position,
the circuit breaker device adapted to receive an opening control signal and to switch from the closed position to the open position when it receives the opening control signal,
the apparatus comprising furthermore:

a voltage comparing means, the voltage comparing means adapted to compare the voltage that is detected by the measuring means with the alarm voltage value and to generate a voltage alarm signal,

a means for generating the opening control signal in the presence of the voltage alarm signal that is produced by the voltage comparing means.

In particular, the apparatus comprises furthermore:

a current comparing means, the current comparing means adapted to compare the ground current with the predetermined alarm ground current value and to generate an current alarm signal,

a means for generating the opening control signal in the presence of the current alarm signal that is produced by the current comparing means.

Said means for generating the opening control signal may be associated with an optical and/or acoustic warning device to produce an optical and/or acoustic warning signal when:

said voltage exceeds the pre-alarm voltage value or

said voltage exceeds the alarm voltage value; or

said ground current exceeds the alarm ground current value.

Preferably, the apparatus comprises:

a central control unit;

a circuit that connects the common ground terminal and the neutral point and detects a signal by means of the central control unit;

a comparator;

wherein the central control unit receives the voltage signal that is detected between common ground terminal and neutral point and transmits it to the comparator, which is adapted to activate the circuit breaker device for automatically blocking the electric supply.

In particular, the central control unit comprises a connecting means for being connected with a plurality of circuit breaker devices, and is adapted to selectively send opening control signals to the circuit breaker devices responsive to signals that are received from the comparator.

In a particular exemplary embodiment, the apparatus comprises a ground resistance measuring means for measuring the ground resistance of the ground wire, wherein the ground resistance measuring means comprises a means for measuring the ground current in the ground wire and a calculating means for calculating the ground resistance as the ratio between the voltage that is established between the neutral point and the ground wire and the ground current.

In particular, the means for measuring the ground resistance is associated with a device for generating a ground resistance signal and with a device for remotely communicating the ground resistance signal.

The above-indicated objects are also achieved by a safety method for an electric installation that is powered through an electric supply line, the electric supply line having a neutral wire and a live wire, the electric installation having a ground wire;

the method comprising the steps of:

measuring a voltage that is established between a neutral point and the ground wire;

disconnecting the electric supply line from the electric installation when the voltage between the neutral point and the ground wire exceeds an alarm voltage value.

Advantageously, the method provides further steps of:

measuring a ground current in the ground wire;

turning off the electric supply when the voltage between the neutral point and the ground wire exceeds the alarm voltage value and when the ground current in the ground wire exceeds an alarm current value.

In a particular exemplary embodiment, the method is a safety method for a plurality of electric installations that are powered through respective electric supply lines, the electric supply lines having respective neutral wires and respective live wires, the electric installations having respective ground wires; the respective ground wires connected to a common ground terminal that is common to more than one installation,

the method comprising the steps of:

measuring the voltage that is established between the neutral point and the common ground terminal;

turning off the electric supply of at least one of the electric installations when the voltage between the neutral point and the common ground terminal exceeds the alarm voltage value.

The step of measuring the ground current in the ground wire may be carried out in the ground wire of each plant, and the step of turning off the electric supply may be carried out for the/each electric installation where the ground current in the respective ground wire exceeds the alarm voltage value.

In particular, the step of turning off the electric supply when the voltage between the neutral point and the ground wire exceeds the alarm voltage value is carried out for all the electric installations.

### BRIEF DESCRIPTION OF THE DRAWINGS

The invention will be now shown with the following description of exemplary embodiments thereof, exemplifying but not limitative, with reference to the attached drawings, in which:

FIG. 1 diagrammatically shows an electric installation of a single living unit that is protected by an apparatus according to the invention, for avoiding harmful voltage on the ground wire and then on the parts of the electric appliances that are connected to the ground wire;

FIG. 2 is a block diagram of an exemplary embodiment of the method according to the invention, that can be actuated by the apparatus of FIG. 1 and FIG. 3;

FIG. 3 diagrammatically shows a plurality of electric installations of a multiple living unit that are protected by an apparatus according to the invention, for preventing harmful voltage from being established on the common ground terminal and then on the parts of electric appliances that are connected to the terminal;

FIG. 4 is a block diagram of another exemplary embodiment of the method, where a pre-alarm voltage value is provided;

FIG. 5 diagrammatically shows a plurality of electric installations as in FIG. 2, that are protected by an apparatus according to another exemplary embodiment of the invention, in which a check of the ground currents coming from the single installations is provided;

FIG. 6 is a block diagram of a further exemplary embodiment of the method, in which a check of the ground currents coming from the single installations is provided;

FIG. 7 represents a relay device for controlling the switches of the electric lines;

FIG. 8 diagrammatically shows a control unit for elaborating the ground current of that flows in the ground wire of a user, for example of a living unit, that is protected by the apparatus shown in FIG. 5;

FIG. 9 diagrammatically shows a control unit for elaborating a signal related to the voltage between the common ground terminal and the neutral point;

FIG. 10 diagrammatically shows the process of identifying a sinusoidal wave that is actuated by the control unit of FIG. 3;

FIG. 11 is a block diagram of the ground resistance measuring means of FIG. 1;

FIG. 12 diagrammatically shows a threshold level setting device for fixing the operating voltage threshold levels and the polarization level of the control unit of FIG. 9.

### DESCRIPTION OF PREFERRED EXEMPLARY EMBODIMENTS

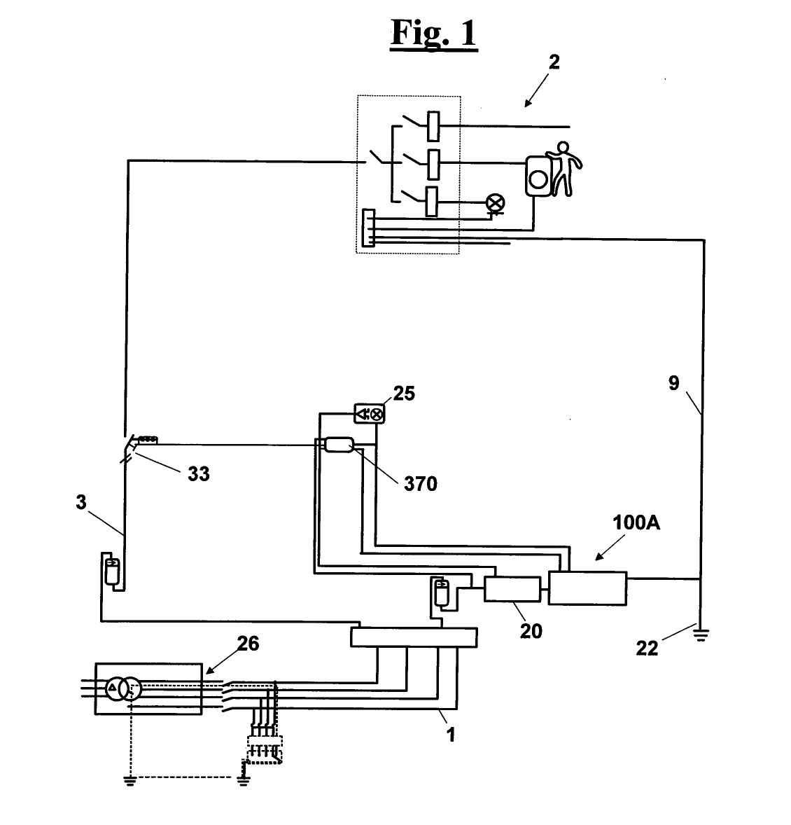

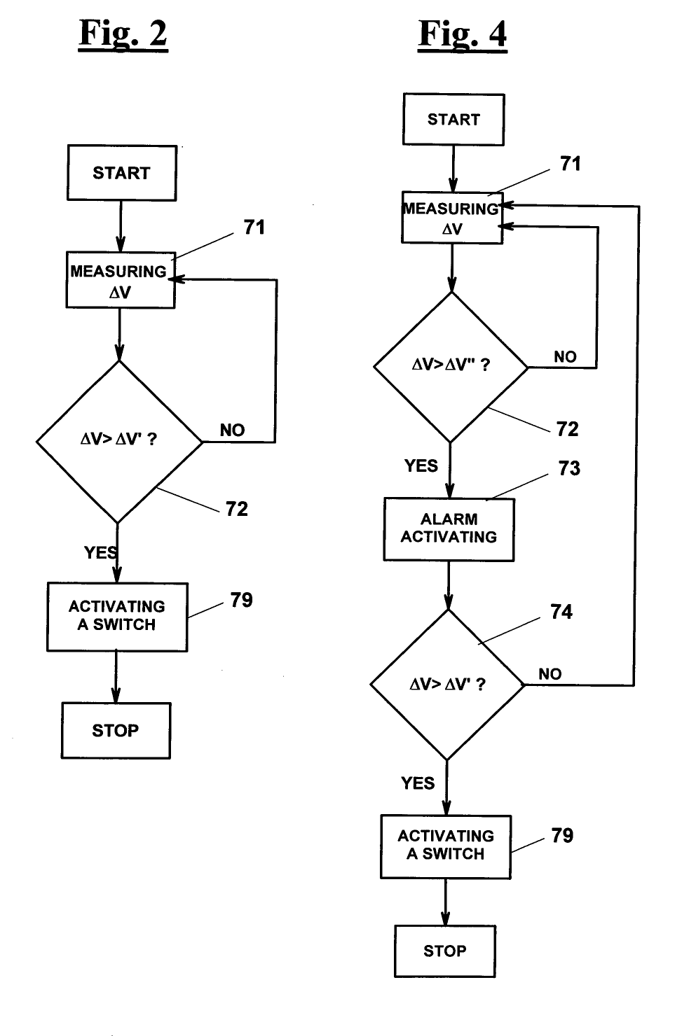

With reference to FIGS. 1 and 2, a safety method and a safety apparatus are described for an electric installation 2 that is powered through an electric supply line 3, and that has a ground wire 9. The safety apparatus comprises a means 400A for carrying out:

a step 71 of automatically measuring a voltage ΔV that is established between neutral point 23 and ground wire 9;

a step 74 of comparing this measured voltage ΔV with an alarm voltage value LV′;

a step 79 of activating a switch 33, by means of a control device, for example a relay device 370, when measured voltage ΔV exceeds an alarm voltage value ΔV′, automatically disconnecting electric supply line 3 from electric installation 2.

By the expression “neutral point” a point is indicated of the neutral wire that is provided by an electric provider, said neutral point electrically connected to neutral output side 1 of the local low-voltage transformer 26.

Optionally, an optical and/or acoustic warning device may be provided 25 that goes off when measured voltage ΔV exceeds alarm voltage value ΔV′.

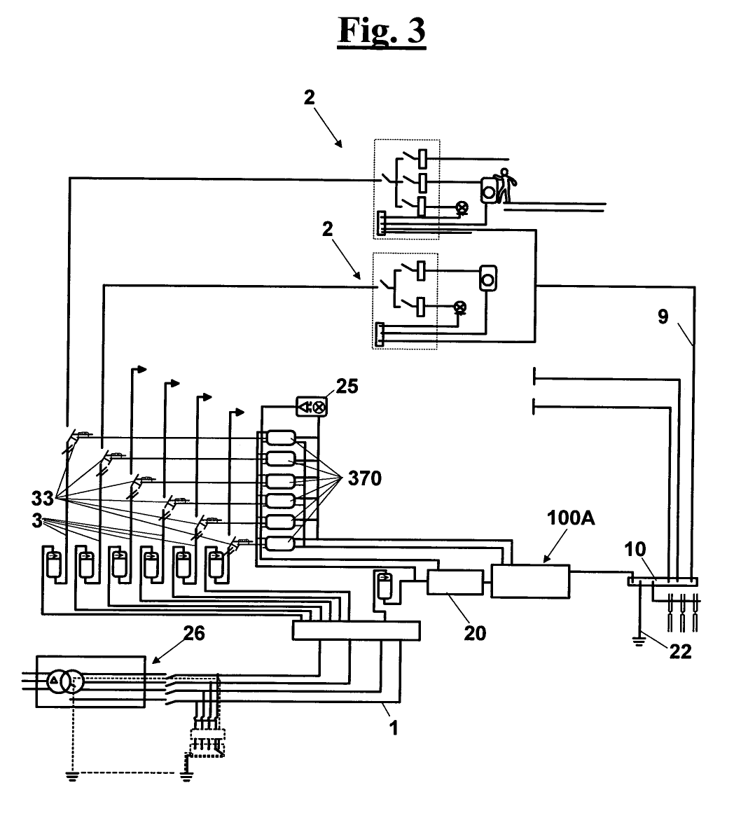

FIG. 3 shows a safety apparatus for a plurality of installations 2 whose ground wires 9 are connected to a common ground terminal 10. The apparatus of FIG. 3 carries out the same method of FIG. 2, in particular, a means 400A carries out:

a step 71 of automatically measuring a voltage ΔV between neutral point 23 and common ground terminal 10;

a step 74 of comparing this measured voltage ΔV with an alarm voltage value ΔV′;
a step 79 of activating a switch 33, by means of a control device, for example a relay device 370, when measured voltage ΔV exceeds an alarm voltage value ΔV′.

Briefly, such devices turn off the electric supply to one or more electric installations that are connected to a ground terminal when the voltage that is established between the neutral point and the ground terminal reaches an anomalous value, i.e. a value that is greater than the values that normally occur in electric installations, which are normally lower than 1 Volt.

FIG. 4 is a block diagram of an exemplary embodiment of the method, which can be actuated by means of the apparatus of FIG. 1 and of FIG. 2, respectively for an installation 2 and for a plurality of electric installations 2. In this exemplary embodiment of the method the following further steps are provided after step 71 of automatically measuring a voltage ΔV that is established between neutral point 23 and ground wire 9:

a step 72 of comparing this measured voltage ΔV with a pre-alarm voltage value ΔV″, which is lower than alarm threshold ΔV′;

a step 73 of activating an optical and/or acoustic alarm device 25.

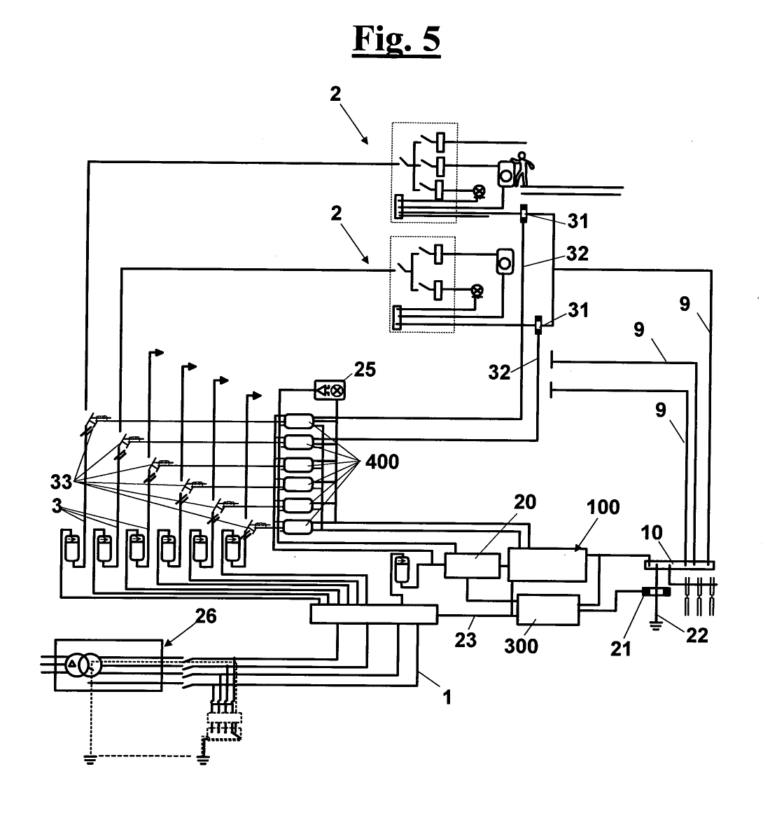

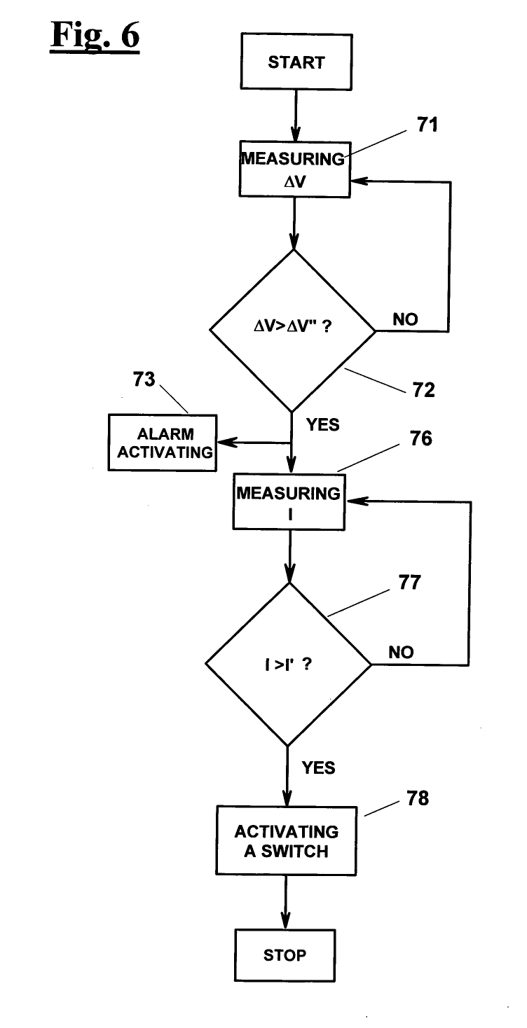

With reference to FIGS. 5 and 6, an exemplary embodiment of the method is described, according to the invention, for safely operating a plurality of electric installations, and an apparatus for carrying out such method is described as well. The safety apparatus comprises a means 100 for carrying out:

a step 71 of automatically measuring a voltage ΔV that is established between neutral point 23 and ground wire 9;

a step 72 of comparing this measured voltage ΔV with a pre-alarm voltage value ΔV″;

a step 76 of automatically measuring the current I in each ground wire 9,

a step 77 of comparing this measured ground current I with an alarm current value I′;

a step 78 of activating a switch 33, by means of a control device 400, which comprises for example a relay device 400B, when the measured ground current I exceeds an alarm current value I′, automatically disconnecting the only electric supply line 3 that electrically supplies electric installation 2 in whose collector 9 a ground current has been detected that is greater than alarm current value I′. Obviously, the apparatus may be suitable for disconnecting all lines 3 when the measured ground current exceeds an alarm current value even in only one ground wire.

Furthermore, it is possible to define an alarm voltage value ΔV and to provide further steps, that means 100 of a safety apparatus still carries out, i.e.

a step 74 of comparing this measured voltage ΔV with an alarm voltage value ΔV′;

a step 79 of activating switch 33, by means of a control device, that is for example a relay device 370, when measured voltage ΔV exceeds an alarm voltage value ΔV′. In this case the apparatus:

provides an alarm signal if measured voltage ΔV between neutral point 23 and common ground terminal 10 exceeds a pre-alarm voltage value ΔV″;

disconnects supply line 3, preferably, only supply line 3 of electric installation 2 in whose ground wire 9 a ground current has been detected greater than alarm current value I′;

disconnects supply line 3 of each installation 2 if voltage ΔV exceeds pre-alarm voltage value ΔV′, which is higher than ΔV″.

Obviously, the method can be actuated by a safety apparatus of a single electric installation, in which measuring a voltage between the neutral point and ground wires 9 replaces measuring the voltage between neutral point 23 and common ground terminal 10.

Voltage and possibly ground current measurements are steadily carried out, which provides a permanent protection.

Ground current I measuring in wire 9 is carried out for each installation 2 by means of a toroidal inductor 31 which is crossed by one or more ground wires 9 that collectively receive the ground connections of all the electric apparatus that are powered through installation 2. On each toroidal inductor 31 a winding is arranged at the ends of which a possible ground current in a wire 9 induces a voltage that is proportional to the ground current of respective installation 2. This voltage is transferred to control unit 400 that protects respective installation 2 by means of a wire 32. This way, ground current I of each installation is steadily detected.

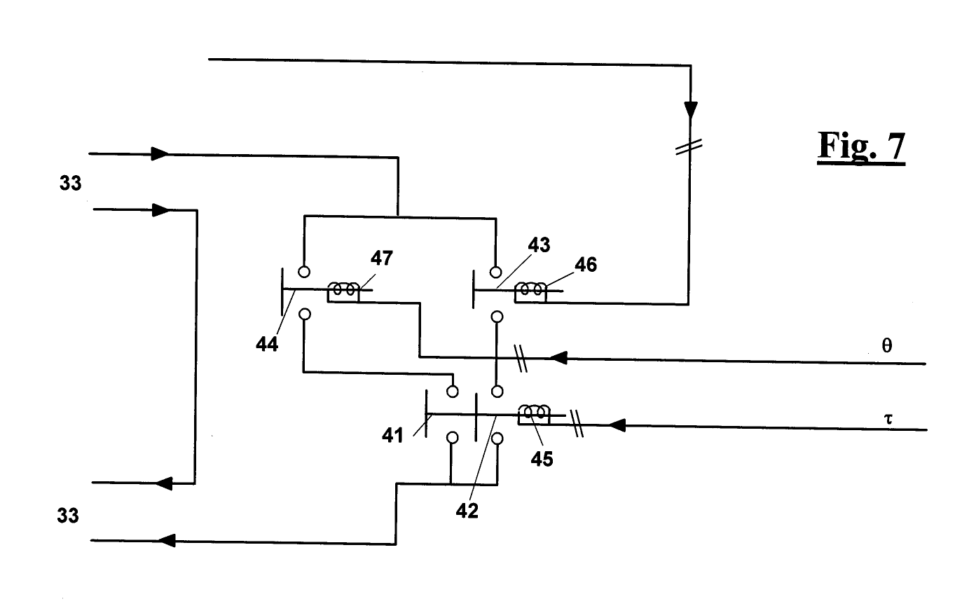

FIG. 7 shows a relay device 400 B for carrying out the steps of activating an optical and/or acoustic signal and activating one or more than one switches 33 (FIGS. 1, 3 and 6). In this device, a voltage signal, which is responsive to the overall ground current and to the ground resistance, closes contacts 41-42 when ΔV>ΔV″. The same signal closes contact 44 of all control units 400 when ΔV>ΔV′ and opens switches 33 of all installations 2. Furthermore, a ground current signal, that is produced by toroidal inductor 31 of an installation 2, closes contact 43, further supplying energy for exciting an actuating device that actuates switch 31, for example a solenoid actuator. As a consequence, electric supply is turned off only to the above mentioned circuit, by opening only switch 33. With reference, for example, to safety means for living units such as flats, for each unit a plurality of switches 33 may be used, each switch disconnecting a group of electric appliances of the flat, a preference system being provided for defining the sequence by which the single switches of the plurality shall be opened.

For example, in case of an accidental contact of a phase conductor with a metal part, for example with the box of an electric appliance that is connected to the safety apparatus, a ground current is created that causes closing, by means of contact 43 of control unit 400 which pertains to a living unit where the contact has occurred and, if this causes the voltage to exceed the pre-alarm voltage value, contacts 41-42 are closed in all control units 400. Therefore, only the switch 33 is opened of the electric installation which pertains the living unit where the failure has taken place.

To prevent this from occurring even in case of a temporary failure due to one flat, a step may be provided of co-ordinately closing contact 44, with a delay, and within allowable time limits, with respect to the time that is needed for closing contacts 43 and 41-42.

Moreover, if owing to the ground current the contact voltage reaches (or exceeds) a dangerous value, the contact 44 of each control unit is closed (even if no dispersion occurs beyond the designed limits, i.e. even if contact 43 is open) of all the circuits that are powered by the electric provider, which are connected by ground wires 9 to common ground terminal 10; this may occur with a delay with respect to the time that is needed for opening the switches (circuit breakers) that are provided to protect the electric installations of a plurality of flats, but in any case coordinated, according to the local rules, responsive to the safety curves.

Still with reference to FIG. 5, the apparatus may comprise a toroidal inductor 21 that is arranged between common ground terminal 10 and ground 22, on which a winding is wound, at the ends of which a voltage is detected that is induced by the overall ground current, and that is proportional to this overall ground current. Such current is used together with voltage ΔV, which is established between the common ground terminal and the neutral point of the transformer, in a ground resistance measuring means 300 that steadily measures the ground resistance. When the ground resistance value reaches a value that, with the current that circulates on the ground wire, causes a dangerous voltage, a means may be provided for opening all the circuits that are powered through the electric provider. A particular case occurs when the ground wire is broken.

Furthermore, the apparatus may comprise a transmission means, not shown, for forwarding a ground resistance value to a control unit, or the alarm signal in case a predetermined ground resistance threshold is exceeded.

In the exemplary embodiments of FIG. 7, contacts 44, 41-42, 43 are normally open, but also normally closed contacts, not shown, could be used instead, without reducing the reliability level of the safety apparatus.

For a higher safety level, even for a three-phase system, the same ground current and ground resistance design values may be assumed, which would occur in the case of a one-phase system, without considering the other two phases that, on the common ground terminal, can mutually compensate due to the phase time shift.

FIG. 5 also shows:

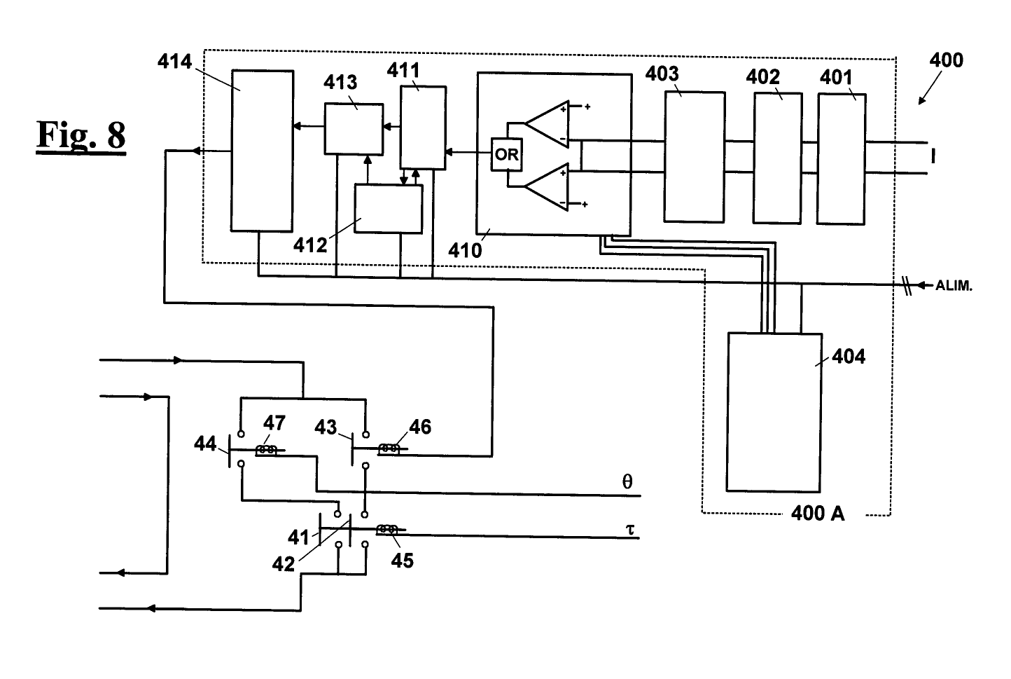

six control units 400, one for each installation 2 that is protected by the safety apparatus, as shown more in detail in FIG. 8;

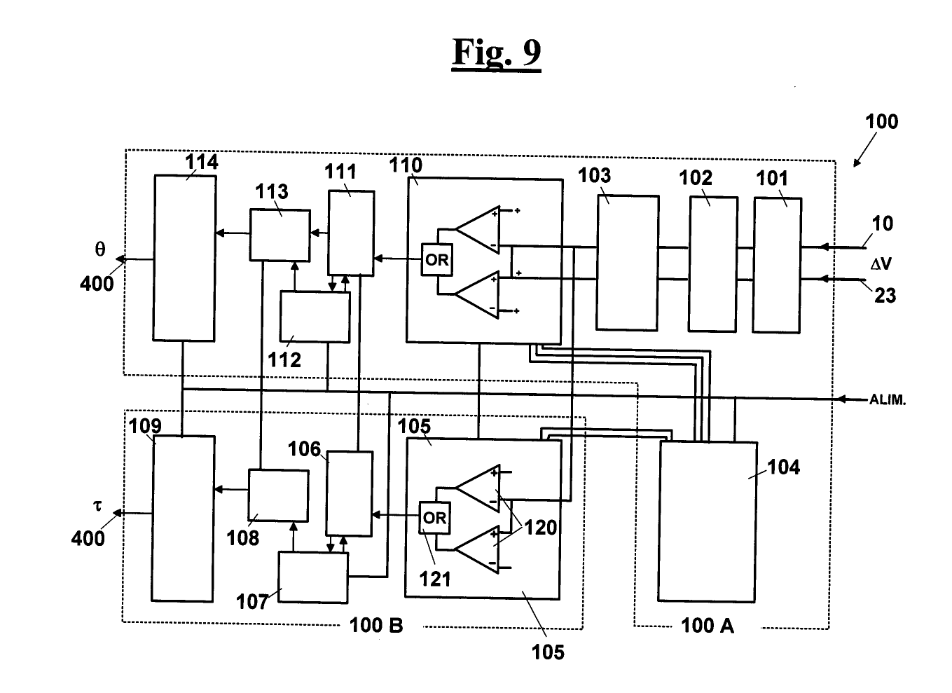

a central control unit 100, as shown more in detail in FIG. 9, which serves for analysing a voltage signal ΔV, and to send it to control units 400 of each installation, in particular, this signal comprises a signal θ that refers to exceeding alarm voltage ΔV′ and a signal τ that refers to exceeding alarm voltage ΔV″;

a power supply 20 of central control unit 100.

Control units 400 and central control unit 100 can be housed in a common case which contains a modular structure that is adapted to receive a number of control units 400 according to the number of installations that must be protected. Control units 400 can be replaced by control units 370 that only contain the relay device, in the case of safety apparatus as shown in FIG. 1 and in FIG. 3, which do not provide checking the ground current/s.

With reference to the block diagram of FIG. 8, an exemplary embodiment is described of control unit 100 for elaborating the voltage signal that is related to the voltage established between common ground terminal 10 and neutral point 23. Central control unit 100 receives signal ΔV that is detected between common ground terminal 10 and neutral point 23, which enters block 101 where the signal is reduced within the comparators working range, by matching the impedances of the source of the signal and of the comparator. This way, the pre-treated output signal is fed to a transient suppression module 102. In a following block 103, the signal is adjusted, by means of potentiometers, up to a level that is adapted to trigger a final piloting as two fixed thresholds (+9.00 Vcc and +3.00 Vcc) are exceeded.

The threshold value and the polarization level are set by means of block 104, an exemplary embodiment of which is shown in FIG. 12. The threshold values of block 4, which are shown in FIG. 12, are purely indicative.

Subsequently, the signal enters decisional block 105, which comprises:

two level comparators 120 (thresholds levels +8.46 Vcc and +3.54 Vcc, polarization level +6.00 Vcc)

an OR node or device 121 that serializes the output of comparators 120 (see FIG. 5).

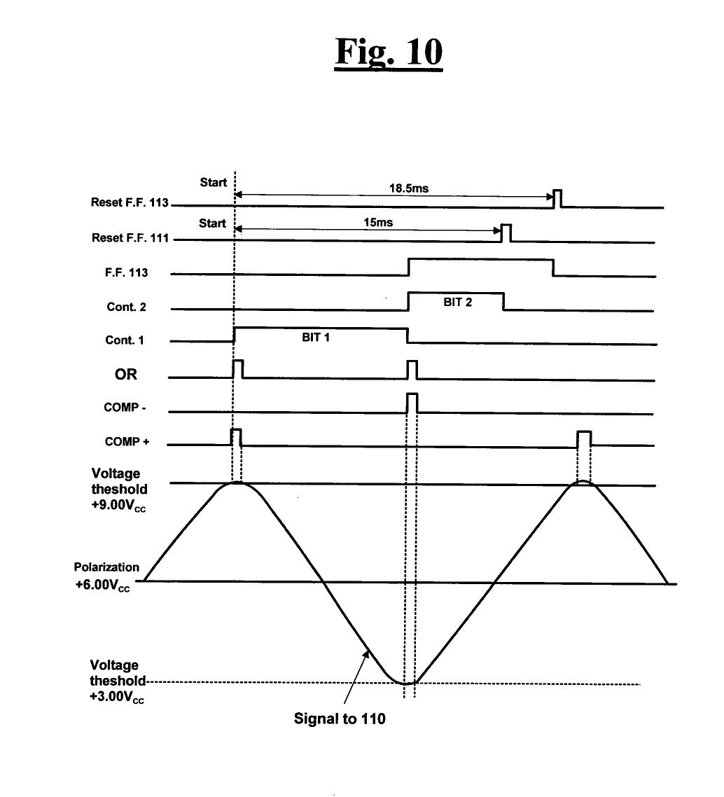

The purpose of block 105 is to detect two semi-sinusoidal consecutive waves, which have an amplitude that is equal to the gap set between the thresholds. Immediately after this ascertainment (two “1” have been computed by the counter 106 that has then activated flip-flop 108), if the two “1” have been recorded in the flip-flop before a reset 107 has been received by the counter, that would otherwise set the counter to zero, in which case the step should be repeated, it is guaranteed that the two semi-sinusoidal waves are equal in amplitude, symmetrical and consecutive, and form therefore a full sinusoidal wave 50 (FIG. 10). Multi-bit counters can also be used to obtain various types of operation.

Afterwards, the commutation at the outlet of flip-flop 108 operates a buffer 109 that feeds both optical/acoustic alarm 25, as schematically shown, for instance, in FIG. 2, and the coil that is associated to contacts 41-42 of control unit 400 (FIG. 4).

Contact 42, which is controlled by a signal produced by block 1006 of central control unit 100 (FIG. 23), is serially connected to contact 43, which in turn is controlled by block 400A of control unit 400, by means of the signal of toroidal inductor 31 that is crossed by the protection cord, i.e. by ground wires 9 of a respective flat.

If this signal shows a signal that is greater than the design value, contact 43 is closed and therefore respective switch 33 is opened.

In case of voltage values that are equal or greater than a dangerous voltage (for the final intervention), central control unit 100, as shown in the block diagrams of FIG. 3, receives a signal that represents the voltage that is established between the common ground terminal and the neutral point; this signal enters block 101 where the signal is reduced within the rough limits of the comparators working range, by matching the impedances of the source of the signal and of the comparator.

The output pre-treated signal thus obtained enters transient suppressing block 102.

In following block 103, the signal is adjusted, by means of potentiometers, to a level that is adapted to trigger the final piloting as the two prefixed thresholds (+9.00 Vcc and +3.00 Vcc) are exceeded.

The threshold value and the polarization level are set through block 104, as shown in FIG. 6.

Then, the signal enters decisional block 110 which consists of:

two level comparators 130 (thresholds +9.00 Vcc and +3.00 Vcc, polarization level +6.00 Vcc)

an OR node or device 131 that serializes the outputs of comparators 130 (see FIG. 5).

The purpose of this circuit is to detect two semi-sinusoidal consecutive waves which have an amplitude equal to the gap set between the thresholds. Immediately after this check (two “1”s have been computed by counter 111 that has then activated flip-flop 113), if the two “1”s have been recorded in the flip-flop before a reset 112 has been received by the counter, that would otherwise set the counter to zero, in which case the step should be repeated, it is guaranteed that the two semi-sinusoidal waves are equal in amplitude, symmetrical and consecutive and form therefore a full sinusoid 50 (FIG. 6).

Also in this case, multi-bit counters can also be used to obtain various types of operation.

The commutation, at the outlet of flip-flop 113 operates a buffer 114 that feeds coil 47 that is associated to contact 44.

FIG. 9 shows an exemplary embodiment of the control unit 400 that is associated with each installation protected by the apparatus, which comprises a means 400A for analysing the ground current signal that is detected in ground wire 9 of each plant. The central control unit is advantageously used in an apparatus for carrying out the method of FIG. 6, and comprises

After the signal of the voltage close to the dangerous voltage value, which causes contacts 41-42 to be closed, there is:

If the ground current pertaining the living unit is larger than the designed value, contact 43 (dependent on block 400A, which operates similarly to block A of central control unit 100) is closed and therefore corresponding manual rearming switch 33 is opened.

Instead, if the dispersion is not greater than the designed value of each flat, contact 43 remains opened, therefore switch 33 (controlled by relative control unit 400) is opened only when contact 44 is closed due to the dangerous voltage.

In case of contact of a phase conductor with a metal part that is connected to the safety apparatus, contacts 43, 41-42 are closed and therefore respective switches 33 are opened.

In order to avoid that a failure at a single living unit causes contacts 44 of all the flats to be closed, a coordinate closing of all contacts 44 is provided, i.e. a delayed closing, within time limits that are allowable, with respect the time that is needed for closing contacts 43, 41-42.

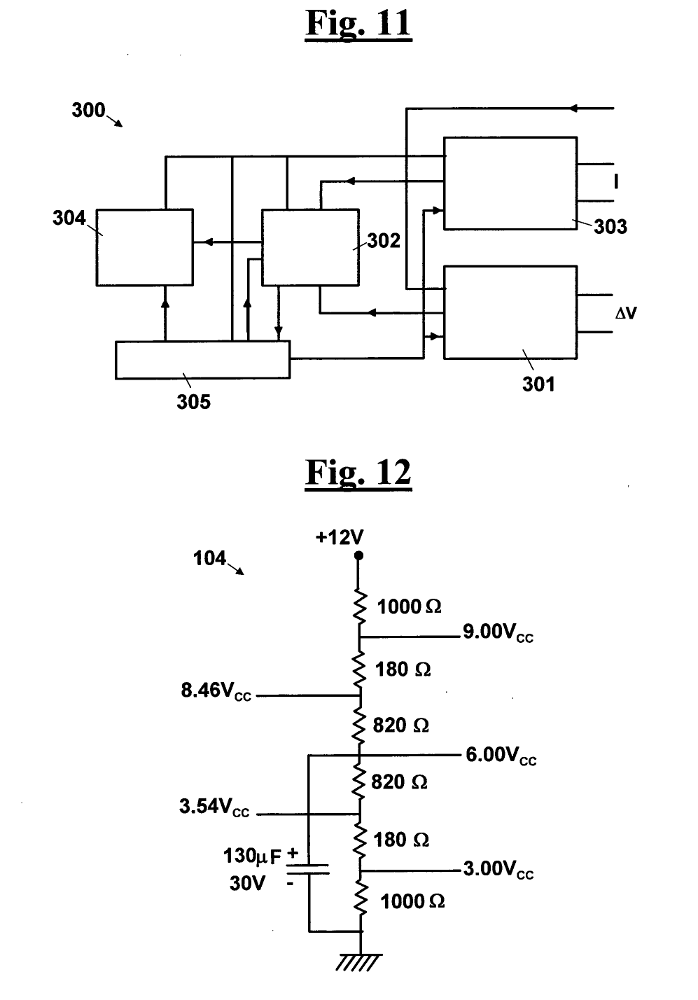

In FIG. 11 a block diagram is given that shows the operation of a ground resistance measuring means 300, which detects:

a value of the voltage that is established between common ground terminal 10 and neutral point 23, by means of a digital voltmeter 301, and that is sent to divider 302;

a digital voltmeter 303, and by means of toroidal inductor 21, a signal that is proportional to the current that circulates through common ground wire 22 and is sent to divider 303.

Divider 302 carries out the division and delivers the result to a displaying device 304, for example to a LCD display, that displays it, according to a timing that has been prefixed by means of timer 305.

The components of the apparatus can be made with a completely digital wiring, which comprises microprocessors. This allows to program the alarm thresholds, and enables to both locally and remotely operation control, which is remarkably advantageous from a safety and economical point of view.

The foregoing description of specific embodiments will so fully reveal the invention according to the conceptual point of view, such that others, by applying current knowledge, will be able to modify and/or adapt for various applications such embodiments without further research and without parting from the invention, and it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology employed herein is for the purpose of description and not of limitation.

1. A safety apparatus for an electric installation, said electric installation powered through an electric supply line, said electric supply line having a neutral wire and a live wire, said electric installation having a ground wire;
said apparatus comprising:
an automatic voltage measuring means for automatically measuring a voltage that is established between a neutral point and said ground wire;
a circuit breaker means that is adapted to work responsive to said voltage measuring means for automatically disconnecting said electric supply line with respect to said electric installation when said voltage between said neutral point and said ground wire exceeds an alarm voltage value.

2. A safety apparatus according to claim 1, wherein a ground current measuring means is furthermore provided for measuring a ground current in said ground wire, and said circuit breaker means is adapted to disconnect said electric supply line from said electric installation when said voltage between said neutral point and said ground wire exceeds said alarm voltage value and when said ground current exceeds an alarm ground current value.

3. A safety apparatus according to claim 1, wherein a signal means is provided for signalling a pre-alarm voltage value when the voltage between said neutral point and said ground wire exceeds a pre-alarm voltage value that is lower than said alarm voltage value.

4. A safety apparatus according to claim 1, wherein said circuit breaker means comprise a circuit breaker device that has:
a closed position, in which said neutral wire and said live wire of said electric supply line are respectively connected to a corresponding neutral wire and to a live wire of said electric installation,
an open position, where at least one wire selected from the group comprised of said neutral wire and said live wire of said electric supply line is not connected to said corresponding neutral wire or live wire of said electric installation,
such that a current is allowed to flow/prevented from flowing between said electric supply line and said electric installation when said circuit breaker device is at said closed/open position,
said circuit breaker device adapted to receive an opening control signal and to switch from said closed position to said open position when it receives said opening control signal, said apparatus comprising furthermore:
a voltage comparing means, said voltage comparing means adapted to compare the voltage that is detected by said measuring means with said alarm voltage value and to generate a voltage alarm signal,
a means for generating said opening control signal in the presence of said voltage alarm signal that is produced by said voltage comparing means.

5. A safety apparatus according to claim 2, additionally comprising:
a current comparing means, said current comparing means adapted to compare said ground current with said predetermined alarm ground current value and to generate a current alarm signal,
a means for generating said opening control signal in the presence of said current alarm signal that is produced by said current comparing means.

6. An apparatus according to claim 1, wherein said means for generating said opening control signal is associated with an optical and/or acoustic warning device such that said warning device produces an optical and/or acoustic warning signal when:
said voltage exceeds said pre-alarm voltage value or
said voltage exceeds said alarm voltage value; or
said ground current exceeds said alarm ground current value.

7. An apparatus according to claim 1, additionally comprising,
a central control unit (100);
a circuit that connects the common ground terminal and said neutral point (23) and detects a signal ΔV by means of said central control unit (100);
a comparator;
wherein said central control unit (100) receives said signal ΔV that is detected between common ground terminal (10) and neutral point (23) and transmits it to said comparator, which is adapted to activate said circuit breaker device for automatically blocking the electric supply.

8. An apparatus according to claim 7, wherein said central control unit comprises a connecting means for being connected with a plurality of circuit breaker devices, and is adapted to selectively send opening control signals to said circuit breaker devices responsive to signals that are received from said comparator.

9. A device according to claim 1 wherein a ground resistance measuring means is provided for measuring the ground resistance of said ground wire, wherein said ground resistance measuring means comprises a means for measuring the ground current in said ground wire and a calculating means for calculating said ground resistance as the ratio between said voltage that is established between said neutral point and said ground wire, and said ground current.

10. A device according to claim 7, wherein said ground resistance measuring means is associated with a device for generating a ground resistance signal and with a device for remotely communicating a ground resistance signal.

11. A safety method for a mains-powered electric installation, said electric installation comprising an electric supply line 1, said electric supply line having a neutral wire and a live wire, said electric installation having a ground wire;
said method comprising the steps of:
measuring a voltage that is established between a neutral point and said ground wire;
disconnecting said electric supply line from said electric installation when said voltage between said neutral point and said ground wire exceeds an alarm voltage value.

12. A safety method according to claim 11, wherein further steps are provided of:
measuring a ground current in said ground wire;
turning off the electric supply when said voltage between said neutral point and said ground wire exceeds said alarm voltage value and when said ground current in said ground wire exceeds an alarm current value.

13. A safety method according to claim 11, said electric installations powered through respective a plurality of electric supply lines, said electric supply lines having respective neutral wires and respective live wires, said electric installations having respective ground wires;
said respective ground wires connected to a common ground terminal that is common to more than one installation,
said method comprising the steps of:
measuring said voltage that is established between said neutral point and said common ground terminal;
turning off the electric supply of at least one of said electric installations when said voltage between said neutral point and said common ground terminal exceeds said alarm voltage value.

14. A safety method for an electric installation according to claim 12, wherein said step of measuring the ground current in said ground wire is carried out in the ground wire of each plant, and said step of turning off the electric supply is effected for said or each electric installation where the ground current in the respective ground wire exceeds said alarm voltage value.

15. A safety method for an electric installation according to claim 13, wherein said step of turning off the electric supply when said voltage between said neutral point and said ground wire exceeds said alarm voltage value is carried out for all of said electric installations.
